(19) United States
(12) Patent Application Publication
(10) Pub. No.: US 2015/0287517 A1
(43) Pub. Date: Oct. 8, 2015

(54) FLAT-WIRE VERTICAL WINDING TOROIDAL INDUCTOR

(71) Applicant: Shenzhen JingQuanHua Electronics Co., Ltd., Shenzhen (CN)

(72) Inventors: GUANGYUAN XIE, Shenzhen (CN); WANJIN JU, Shenzhen (CN)

(73) Assignee: JingQuanHua Electronics Co., Ltd.

(21) Appl. No.: 14/658,782

(22) Filed: Mar. 16, 2015

(30) Foreign Application Priority Data
Apr. 3, 2014 (CN) 2014-20160136.4

(51) Int. Cl. H01F 27/28; H01F 27/29

(52) U.S. Cl. CPC H01F 27/2823; H01F 27/29; H01F 27/2895

(57) ABSTRACT

The present invention discloses a flat-wire vertical winding toroidal inductor, includes a toroidal inductor core, characterized in, it also includes a plurality of flat-wires wound on the said toroidal inductor core, whose cross section shows a hollow rectangular shape; wherein, each end of two adjacent flat-wires among the said plurality of flat-wires connects to a leading-out bare wire, which is used to connect to the circuit board. Due to adopting flat-wire single layer winding method, that makes the distance between wire loops pretty large, without any overlaps, thus the electric capacity between coil loops is pretty small; also, the coil loops are arranged totally in a fan-shaped style, which has a large interface with air, ensuring full heat dispersion. Thus, under the same conditions in cross areas, temperature raise in the present invention is lower than that of a round wire.

### CROSS-REFERENCES TO RELATED APPLICATIONS

This application claims the priority of Chinese patent application no. 201420160136.4, filed on Apr. 3, 2014, the entire contents of all of which are incorporated herein by reference.

### TECHNICAL FIELD OF THE DISCLOSURE

The present invention relates to the field of inductor technology area, and more particularly, to a flat-wire vertical winding toroidal inductor.

### BACKGROUND ART OF THE DISCLOSURE

In the prior art, a toroidal inductor usually includes an annular ring-shaped inductor core and insulated wire coils wound on the toroidal core. In order to change the power of a toroidal inductor, it is used to change the insulated wire diameter or the winding rounds of the insulated wire. When the ring radius of the inductor core is fixed, if increasing the power of the toroidal inductor is needed, then applying a larger diameter insulated wire to wind to the ring or increasing the number of winding turns of the insulated wire will be required. However, both methods make the toroidal inductor look very “fat”, and not conducive for wire cooling.

Therefore, the prior art needs to be improved and developed.

### BRIEF SUMMARY OF THE DISCLOSURE

The technical problems to be solved in the present invention is, aiming at the defects of the prior art, providing a flat-wire vertical winding toroidal inductor.

The technical solution of the present invention to solve the said technical problems is as follows:

A flat-wire vertical winding toroidal inductor, includes a toroidal inductor core, characterized in, it also includes a plurality of flat-wires wound on the said toroidal inductor core, whose cross section shows a hollow rectangular shape; wherein, each end of two adjacent flat-wires among the said plurality of flat-wires connects to a leading-out bare wire, which is used to connect to the circuit board.

The said flat-wire vertical winding toroidal inductor, wherein, the said flat-wire and the adjacent ones are arranged in a fan shape.

The said flat-wire vertical winding toroidal inductor, wherein, the said leading-out bare wire is stamped into a flat shape.

The said flat-wire vertical winding toroidal inductor, wherein, the angle between the said flat-wire and the adjacent one is 5°-10°.

The said flat-wire vertical winding toroidal inductor, wherein, the cable width of the said flat-wire is 1 cm-3 cm.

The said flat-wire vertical winding toroidal inductor, wherein, the said flat-wire is a copper strip, aluminum strip, tin strip, silver strip or gold strip.

Benefits of the Present Invention:

The flat-wire vertical winding toroidal inductor, as provided in the present invention, due to adopting flat-wire single layer winding method, which makes the distance between wire loops pretty large, without any overlaps, thus the electric capacity between the coil loops is pretty small; also, the coil loops are arranged totally in a fan-shaped style, which has a large interface with air, that ensures full heat dispersion, thus, under the same conditions in cross areas, temperature raise in the present invention is lower than that of a round wire.

### BRIEF DESCRIPTION OF THE DRAWINGS

FIG. 1 illustrates the schematic diagram of a preferred embodiment on the flat-wire vertical winding toroidal inductor in the present invention.

FIG. 2 illustrates the section diagram of a preferred embodiment on the flat-wire vertical winding toroidal inductor in the present invention.

### DETAILED DESCRIPTION

In order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

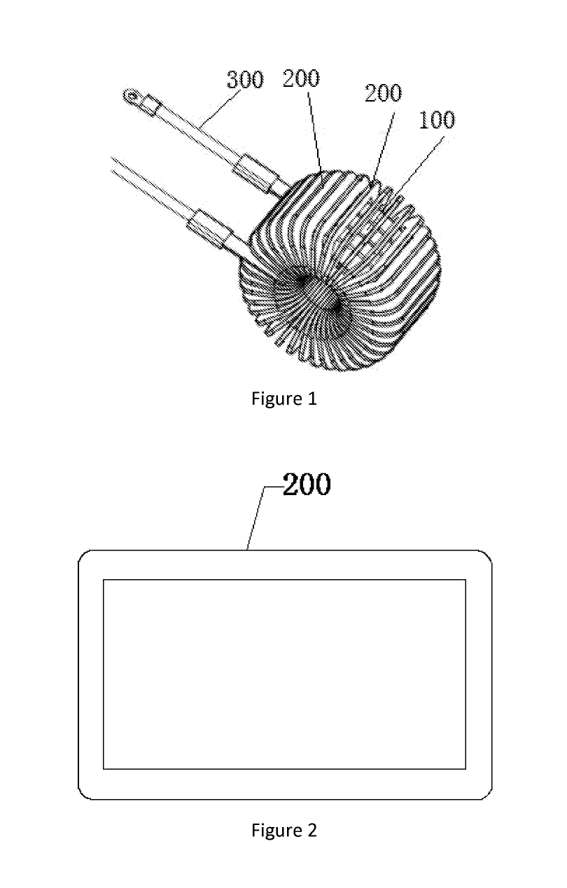

Referencing to FIG. 1, which is the schematic diagram of a preferred embodiment on the flat-wire vertical winding toroidal inductor in the present invention, wherein, the said flat-wire vertical winding toroidal inductor includes a toroidal inductor core 100, which also includes:

A plurality of flat-wires 200 wound on the said toroidal inductor core 100, whose cross section shows a hollow rectangular shape; wherein, each end of the two adjacent flat-wires among the said plurality of flat-wires connects to a leading-out bare wire 300, which is used to connect to the circuit board.

In a preferred embodiment of the present invention, the difference between the said flat-wire 200 and a commonly used round wire is that, its cross section shows a hollow polygonal or a circular shape, thus, when winding the said flat-wire 200 onto the said toroidal inductor core 100, the adjacent two flat-wires are not touching each other tightly, instead, there is a certain distance between each other, and shows a certain angles, thus the interface area between the flat-wire and air is large, which makes a full heat dispersion, and its temperature raise is lower than that of a round wire, under the condition of same cross areas.

Preferably, the said flat-wire 200 and its adjacent flat-wires are arranged in a fan shape. Arranging the two adjacent flat-wires in a fan shape, maximizes the touch area between the flat-wire coil and air, thus achieves the best heat dispersion effects.

Preferably, the said leading-out bare wire 300 is stamped into a flat shape. That is, after stamping, both upper and lower terminals of the said leading-out bare wire 300 are flat planes, and its thickness is less than the width, while its lower terminal touches the circuit board and the interface is a flat plane, which is the welding surface between the leading-out bare wires 300 and the circuit board. When installing the said flat-wire vertical winding toroidal inductor, the two leading-out bare wires 300 are soldered to the circuit board separately.

Preferably, the angle between the said flat-wire and the adjacent one is 5°-10°. While arranging two adjacent flat-wires into a fan shape, a certain angle must exist between the two adjacent flat-wires, which, in a preferred embodiment of the present invention, is set between 5°-10°, thus it is possible to wind 36 to 48 sets of flat-wire coils onto the toroidal inductor core 100. Winding the above said sets of flat-wire coils onto the toroidal inductor core at the same time, will not only fulfill the preset designed power requirement for the toroidal inductor, but also achieve the best heat dispersion effects.

In a preferred embodiment of the present invention, the radius size of the toroidal inductor core 100 is first obtained, then based on this obtained radius size, the inner hollow area size of the flat-wire 200 (that is, the hollow area in the flat-wire cross section) will be decided, followed by producing the flat-wire 200 based on the above said sizes of the inner hollow area, and finally winding the flat-wire 200 onto the toroidal inductor core 100; at the same time, arranging two leading-out bare wires 300 onto the flat-wire 200, which are used to connect the circuit board, and, finally, a flat-wire vertical winding toroidal inductor as described in the present invention will be achieved.

Preferably, the cable width of the said flat-wire 200 is 1 cm-3 cm. As shown in FIG. 2, which is the section diagram of a preferred embodiment on the flat-wire vertical winding toroidal inductor in the present invention. The cross section of the flat-wire as described in this preferred embodiment of the present invention is hollow rectangular shaped, with a cable width 1 cm-3 cm. Obviously, in order to achieve the inductor a larger power, one of the methods is increasing the cable width, which owns the same principle of increasing round cable diameters to increase the power of a inductor, as adopted by those inductors with round wires in current technologies. In a preferred embodiment of the present invention, the cable width of the flat-wire is set to be 1 cm-3 cm, which fulfills the preset designed power requirements, while saving the material usage for wires.

Preferably, the said flat-wire 200 is a copper strip, aluminum strip, tin strip, silver strip or gold strip. The commonly used electric conductor materials include copper, aluminum, tin, silver and gold, wherein, silver is the best metal electric conductor, followed by gold, their price is pretty high. In our daily life, due to its relatively low price, copper is the most selected metal to make wires, while both tin and aluminum are also used for wires in several rare cases. In the stated preferred embodiments of the present invention, copper strips, in the first priority, are also selected to make the flat-wires, which can both save the cost of the toroidal inductor, and achieve the designed requirements of the preset power for the toroidal inductor.

In summary, the present invention provides a flat-wire vertical winding toroidal inductor, includes a toroidal inductor core, characterized in, it also includes a plurality of flat-wires wound on the said toroidal inductor core, whose cross section shows a hollow rectangular shape; wherein, each end of two adjacent flat-wires among the said plurality of flat-wires connects to a leading-out bare wire, which is used to connect to the circuit board. Due to adopting flat-wire single layer winding method, which makes the distance between wire loops pretty large, without any overlaps, the electric capacity between coil loops is pretty small; also, the coil loops are arranged totally in a fan-shaped style, which has a large interface with air, that ensures a full heat dispersion, thus, under the same conditions in section areas, temperature raise in the present invention is lower than that of a round wire.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. A flat-wire vertical winding toroidal inductor, comprises a toroidal inductor core, characterized in, it also includes a plurality of flat-wires wound on the said toroidal inductor core, whose cross section shows a hollow rectangular shape; wherein, each end of the two adjacent flat-wires among the said plurality of flat-wires connects to a leading-out bare wire, which is used to connect to the circuit board.

2. The said flat-wire vertical winding toroidal inductor, according to claim 1, wherein, the said flat-wire and the adjacent ones are arranged in a fan shape.

3. The said flat-wire vertical winding toroidal inductor, according to claim 1, wherein, the said leading-out bare wire is stamped into a flat shape.

4. The said flat-wire vertical winding toroidal inductor, according to claim 2, wherein, the angle between the said flat-wire and the adjacent one is 5°-10°.

5. The said flat-wire vertical winding toroidal inductor, according to claim 1, wherein, the cable width of the said flat-wire is 1 cm-3 cm.

6. The said flat-wire vertical winding toroidal inductor, according to claim 1, wherein, the said flat-wire is a copper strip, aluminum strip, tin strip, silver strip or gold strip.

7. The said flat-wire vertical winding toroidal inductor, according to claim 2, wherein, the said flat-wire is a copper strip, aluminum strip, tin strip, silver strip or gold strip.

8. The said flat-wire vertical winding toroidal inductor, according to claim 3, wherein, the said flat-wire is a copper strip, aluminum strip, tin strip, silver strip or gold strip.

9. The said flat-wire vertical winding toroidal inductor, according to claim 4, wherein, the said flat-wire is a copper strip, aluminum strip, tin strip, silver strip or gold strip.

10. The said flat-wire vertical winding toroidal inductor, according to claim 5, wherein, the said flat-wire is a copper strip, aluminum strip, tin strip, silver strip or gold strip.
